(19) United States
(12) Patent Application Publication
(10) Pub. No.: US 2006/0196181 A1
(43) Pub. Date: Sep. 7, 2006

(54) NELSON FLYWHEEL POWER PLANT

(76) Inventor: Rodney Nelson, Princeton, NC (US)

Correspondence Address: LOUIS VENTRE, JR, 2483 OAKTON HILLS DRIVE, OAKTON, VA, 22124-1530, US

(21) Appl. No.: 10/906,685

(22) Filed: Mar. 2, 2005

(51) Int. Cl. F03B 17/02

(52) U.S. Cl. 60/495

(57) ABSTRACT

A power plant and a process of using the power plant are disclosed. The power plant is composed of a housing rotatably fixed around a stationary shaft. The shaft is ported to allow fluid flow and has projections to serve as walls of chambers holding the motive incompressible fluid in the operation of the invention. A spool with ports and channels fits within the shaft and its axial cyclic motion opens and closes the ports to permit the flow of fluids. The invention includes a means for pressurizing a compressible fluid to drive an incompressible fluid through nozzles or blades to rotate the housing.

### BACKGROUND OF THE INVENTION

The Nelson Flywheel Power Plant converts heat and potential energy to kinetic energy very efficiently and with a potential for significantly less pollution than state of the art heat engines. A power plant and a process of using the power plant are described.

1. Field of the Invention

The invention relates generally to power plants in the field of reaction motors employing combustion or other energy means to generate a compressible fluid that motivates an incompressible fluid to motive a flywheel. Specifically, the invention has uses in stationary power plant applications to produce electrical energy or hydraulic power, in energy storage applications, and in mobile vehicles applications as an engine or motive power source. The power plant is operable using any fuel source capable of generating heat or pressurized gas.

The power plant converts pressure and heat energy in the pressurized gas to kinetic energy of a rotating flywheel by employing a recycling incompressible motive fluid. The power plant uses a single-phase motive fluid, that is, the motive fluid remains primarily in liquid state and is distinguished from two-phase (gas/liquid) engines. The products of combustion together with a recyclable liquid motive fluid may be used. Energy is stored in the flywheel and extracted as needed.

2. Description of Related Art

The concept of using a liquid motivated by a combustion process is described in U.S. Pat. No. 3,990,228 (228 patent). The present invention, as discussed below, is far simpler and inherently different in configuration and energy storage. In the 228 patent, the chambers are themselves rotated about a central axis. The present invention is different in that the chambers do not rotate about a central axis, rather they are fixed on three sides and only the outer wall, which is the inner wall of a flywheel, rotates. The 228 patent uses valves and springs within the chambers, which are required to be mirrored to maintain rotational balance. In the present invention, there are no equivalent valves or springs within the chambers. In the 228 patent, the function of the movement of the working fluid is, as it is in most traditional turbines, to turn a shaft upon which the blades are fixed. Power is taken directly off the shaft as needed. The present invention is a significant departure from this approach. There is no central rotating shaft and the blades serve a larger purpose than simply a direct turning a shaft. In the present invention, the blades are combined in a flywheel, which stores energy and at the same time is available to provide power. Finally, the 228 patent requires symmetry between the chambers in order to operate correctly. The present invention is much more flexible in that symmetry of the port structure in the chambers is not required.

Prior art using two unlike fluids in a motor sometimes employ a rotor acting in the nature of a piston, as in U.S. Pat. No. 3,869,863 (863 patent). In the 863 patent, steam under pressure and hot products of combustion simultaneously drive the rotor. The present invention is different than the 863 patent in that no gaseous products are used to directly drive the flywheel, only liquid, that is, an incompressible fluid is so used. Products of combustion are used impart their energy to motivate the incompressible fluid, which in turn drives the flywheel.

Similarly, some prior art uses combustion products to create steam, which is then used to drive a turbine, as in U.S. Pat. No. 926,157 (157 patent). The stated advantage of the 157 patent is that it uses lower temperature steam on the turbine to attenuate the destructiveness of high temperature on the turbine blades. In the 157 patent, the turbine is not a flywheel and steam was thought necessary to derive sufficient power from the turning blades. The present invention takes the advantage of lower temperature significantly further by using relatively cool liquid as the motivating fluid. The present invention makes further improvements essentially by making the turbine a flywheel, which is capable of storing energy it extracts from the motivating fluid.

Other prior art employ liquid pistons, such as U.S. Pat. No. 3,121,311. The 311 patent employs an eccentric internal rotating impeller to rotate a housing through friction. The arms of the internal rotating impeller form chambers in which combustion drives the liquid. The present invention eliminates for timed combustion within a rotating impeller.

The history of the development of engines is described in U.S. Pat. No. 4,466,245 (245 Patent), which discloses a power plant having a fluid powered flywheel. Typical of these types of prior art, turbine blades and flywheel rotate on a journal shaft connecting the two components.

In the present invention, the flywheel rotates about a fixed and non-rotating shaft and is not co-located on a journal shaft with a separate impeller. In the 245 patent, the pressurized liquid must be delivered to a central region of the flywheel and is then directed through runners to an exit from the housing enclosing the turbine. In the present invention, the fluid is not directed through runners. Rather, the incompressible fluid is already present in the chamber and remains within the turbine housing even after it motivates the flywheel. An advantage of the present invention is that significantly less energy is involved in delivering the motivating fluid to the impeller and returning it to its reservoir. In the 245 patent, the flywheel is separated from the impeller but connected via mounting on the same rotating shaft. Also in the 245 patent, the flywheel is not in contact with the motivating fluid. In the present invention, the means for rotating the flywheel are mounted on the flywheel, which is in direct contact with the motivating fluid.

An object of the present invention is more efficient operation obtained by extracting more useful energy from the fuel used in the power plant. The motivating fluid is moved short distances between outer chambers and each conveyance of the motivating fluid turns the flywheel. For vehicle applications, the present invention potentially translates to a doubling of the miles per gallon in full sized vehicles powered by internal combustion engines. For electricity production, it promises electricity costs of about two cents per kilowatt-hour.

Higher efficiency is attained in part by allowing extraordinary expansion in the power phase of the cycle. The combustion process is used primarily as a mechanism for expansion to drive the working fluid. Thus, the fuel does not have to power the same power strokes required in an internal combustion engine, namely a compression or exhaust stroke. Elimination of these extra strokes improves efficiency.

A greater overall power plant efficiency is delivered because the Nelson Flywheel Power Plant stores unneeded energy in a flywheel. In addition, it has no moving parts exposed to extreme temperatures, allowing the chambers to be constructed of or coated by non heat-conducting material. This is dramatically different from power from internal combustion engines because very little of the heat energy produced is lost in heat transfer. For traditional heat engines, up to 65% of the heat energy of the fuel is lost and unusable. Additionally, the Nelson Flywheel Power Plant permits the extraction of power at sustained levels at a given range of load demands. The ability to store energy, deliver power at sustained levels, and minimization of heat loss to the containing structure delivers high efficiency.

The Nelson Flywheel Power Plant has potential for significantly less pollution than currently available heat engines because it is suitable for use with nearly pure oxygen for fuel combustion. A capacity to use nearly pure oxygen has environmental advantages for vehicle motor applications. The use of oxygen instead of atmospheric air in the fuel mix provides more complete combustion of the fuel at higher temperatures in comparison to present day internal combustion engines, which are prone to incomplete combustion and limited use of the energy in the power stroke. The power plant greatly reduces particulate carbon emissions and carbon monoxide and the formation of nitrogen oxides. The carbon and hydrogen in the fuel are converted to carbon dioxide and water. The system can also operate with atmospheric air or an oxygen enriched mix in various proportions, with proportionately less favorable results.

### BRIEF SUMMARY OF THE INVENTION

A power plant and a process of using the power plant are disclosed. The power plant is composed of a housing rotatably fixed around a shaft. The shaft is ported to allow fluid flow and has projections to serve as walls of chambers holding the motive fluid in the operation of the invention. A spool with ports and channels fits within the shaft and its axial cyclic motion opens and closes the ports to permit the flow of fluids. The invention includes a means for pressurizing a compressible fluid to drive an incompressible fluid through nozzles or blades to rotate the housing.

### BRIEF DESCRIPTION OF THE DRAWINGS

FIG. 1 shows a cross-section of the power plant internals.

FIG. 2 shows a cross-section of the spool.

FIG. 3 is an isometric drawing of invention with hydraulic power take-off and precessional control.

### DETAILED DESCRIPTION OF THE INVENTION

The apparatus of this invention is a power plant. The power plant may be stationary, that is, in a fixed position, or motive, such as in a moving vehicle. Reference is made to the Figures. The most basic embodiment of the power plant, as more fully explained below, includes a rotatable housing (10), a shaft (14) with ports (51A, 51B, 52A, 52B, 53A, 53B, 54A, 54B, 55, 56, and 90) and projections (12) about which the housing rotates, a spool (15) with ports and channels fitting within the shaft, means for pressurizing a fluid, and means for rotating the housing (13).

In this basic embodiment, the power plant is composed of a heavy walled housing, which in operation rotates about a non-rotating shaft to which it is sealed, using a bearing and seal (28), which are well known in the art. The housing is typically a right circular cylindrical body, although any shape consistent with rotation about a shaft would be workable. The housing constitutes a flywheel and thus is best constructed having a larger mass in the wall surrounding the axial dimension of the housing. The housing surrounds chambers created by fixed walls extending from the non-rotating shaft to the immediate vicinity of the housing body. Immediately above each of two of the fixed walls and attached to the housing is at least one nozzle (13), but preferably a circumferential row of nozzles, or turbine blades, or a combination thereof. These serve to rotate the housing during operation of the power plant.

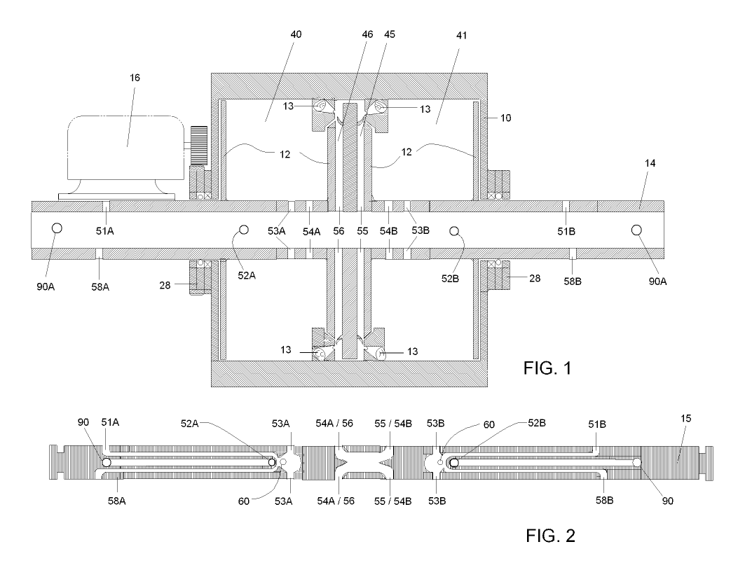

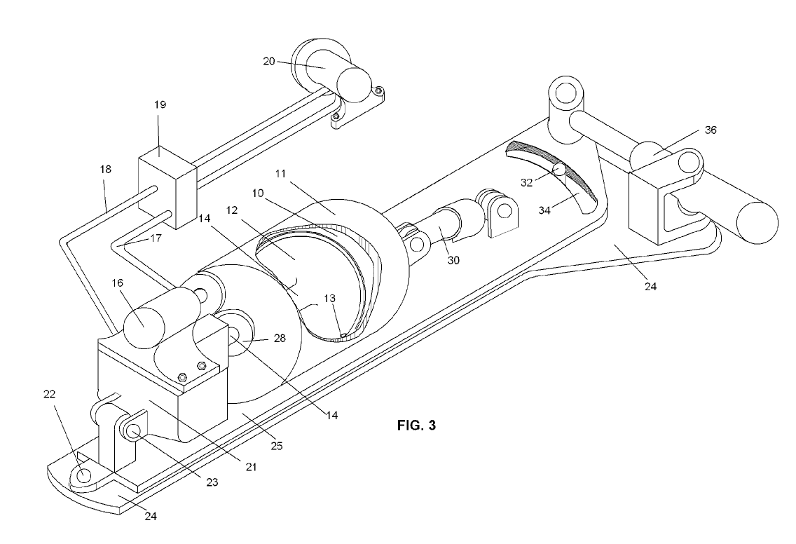

The shaft is a tube of any cross-sectional shape, although in the preferred embodiment, the shaft is circular. The shaft has fixed projections (12), or walls, extending from its outside surface to a practical distance from the circumferential wall of the housing, which permits non-interference with housing rotation. At a minimum these projections form four chambers (40, 41, 45, and 46) within the housing (10). A set of four chambers is needed for operation of the power plant in its most basic embodiment. Any number of additional sets of four chambers may be repeated along the same shaft within the housing. As shown in FIG. 1, in each set of chambers, there is a left outer chamber (40), two inner chambers (45 and 46) and a right outer chamber (41). Thus, in the basic power plant, five projections, or walls, extending from the shaft are required. If additional sets of chambers are on the same shaft, one wall can be shared by adjacent sets of chambers and therefore one less projection is required for the sets beyond the first. In alternate embodiments, the common inner wall between the two inner chambers is fitted with fixed turbine blades to guide incompressible fluid flow out of the inner chambers.

The shaft is ported, that is, has holes extending through the wall of the shaft. Since the chambers extend the full circumference of the shaft, the ports may be aligned to any of the 360 degrees surrounding the shaft that may be convenient to operation. The ports allow the flow of fluids, namely, compressed gases or combustion fluids (53A and 53B), exhaust gases (52A and 52B) or incompressible liquids (54A, 54B, 55 and 56) between the chambers or to the environment external to the housing in accordance with the operation of the power plant. In the preferred embodiment, each outer chamber encloses three sets of two ports on the shaft and each inner chamber encloses one set two ports on the shaft. In the preferred embodiment, the ports in each set of two ports are generally on opposite sides of the shaft, that is, 180 degrees apart on the shaft in order to balance the forces.

In other embodiments, additional paired ports are spaced apart at various angles from each other to provide additional flow paths. In the preferred embodiment, the three sets of ports in each outer chamber are for exhaust of compressible fluids (52A and 52B), compressed gas injection (53A and 53B), and incompressible fluid injection (54A and 54B). In alternate embodiments, the compressed gas injection ports are used for fuel mix injection. For the preferred embodiment, the one set of two ports (55 and 56) in each inner chamber (45 and 46, respectively) are for transferring incompressible fluid subsequent to passage from one outer chamber through the nozzles or turbine blades to the other outer chamber.

A ported spool (15) with flow channels fits within the shaft, such that the axial movement of the spool from one position to another opens or closes sets of ports in the shaft in accordance with the operation of the power plant. The spool has ports outside the housing (51A, 5B, 58A, and 58B) as needed to permit introduction of fuel (57A, 57B, 58A and 58B) or pressurized gas (51A and 51B) and to permit removal of exhaust gas (50A and 50B). There are many options in constructing passages in the spool. For example, a groove can be machined circumferentially allowing one or more accesses to a common channel or at any desired angle. In addition, the invention will work best when the ports on a spool also have seals such as “O” rings when connecting with the ports on the shaft. As shown in FIG. 1, symmetry in the location of the ports in the outer chambers is not required. Since the shaft does not rotate, the balance provided by symmetry is not significant.

In operation, one or more sensors in the outer chambers cyclically actuate the spool to its required position. In the preferred embodiment, the sensors detect incompressible fluid level in the outer chamber being filled. When that chamber reaches a predetermined fill level, the sensor actuates a force to relocate the spool to the alternate position. In alternative embodiments sensors may be located in the outer chamber being emptied and may be pressure or water level sensors. Other sensor locations will be apparent to those skilled in the art.

There are three primary means for pressurizing a compressible fluid in an outer chamber. In the preferred embodiment, an external combustion chamber burns a fuel and oxygen mix to create a pressurized gas pulse added to the outer chamber through the ports for compressed gas injection. In alternate embodiments, there is direct combustion of a fuel mix introduced into an outer chamber through the fuel mix injection port. Direct combustion is accomplished by means well known in the art, such as a spark plug (60) or ignition source in the spool or in that outer chamber.

There are three primary means for imparting rotational energy to the housing by fluid flow from an outer chamber in each set through an adjacent inner chamber to the other outer chamber. The first is one or more nozzles (13) affixed to the inner wall of the housing directly above the two fixed outer walls of the inner chambers. In the preferred embodiment a circumferential row of nozzles is so located above each such wall. The second means are turbine blades above each such wall. The third is a combination of nozzles and turbine blades above each such wall.

In an alternate embodiment, the invention includes a means to control and utilize the precessional forces resulting from a change in direction of a rotating mass. Even in a stationary application, small vibrational movements sometimes generate large precessional forces.

Precession or gyroscopic precession is a twisting force on the axis of a rotating body resulting from any applied tipping force, or force which changes the direction of the spinning body.

For this embodiment, the power plant is affixed to hydraulic lifters (30 and 36), which provide the ability to independently rotate the power plant in the horizontal and vertical directions in response to the precessional forces. The hydraulic lifters neutralize or compensate for these forces and their use in the invention avoids destructive stress and vibrations to anything to which the power plant is mounted or attached. When the power plant is used in applications where it is moving or moveable, such as in a moving vehicle, the means to control and utilize the precession forces are even more important.

Vertical direction control is obtained by enclosing the housing rigid casing (11). One end of the casing is mounted to a base plate (25) by a horizontal axis pivot (23). The other end of the casing is fixed to the ram (30) of a hydraulic lifter. The hydraulic lifter is in turn rotatably affixed to the base plate (25). This pivoted hydraulic connection permits controlled rotation of the casing in the vertical direction around the vertical axis pivot.

Horizontal direction control is obtained by connecting one end of the base plate to a mainframe plate (24) by vertical axis pivot (22), which permits rotational movement of the base plate around the pivot with respect to the mainframe plate. The other end of the base plate is slotted (34) to receive a guide pin (32) fixed in the mainframe plate. The guide pin limits displacement in the horizontal direction to the extent of the slot.

In operation, the power plant stores and delivers energy in a rotating housing or flywheel (10), which may be employed in any number of well-known uses where rotational energy may be converted to other forms of energy. As examples, it may be connected to a generator to produce electrical energy, to a hydraulic pump (16) to provide hydraulic power to wheels (20) or to other devices. A hydraulic power directional controller (19) connected with hydraulic power conduits (17 and 18) permit power to be directed to the wheels or sent back to rotate the flywheel. Geared (28), pullied or direct connections to convert rotational energy to other forms of energy for such applications are well known in the art. Hydraulic power takeoff offers a means to deliver high torque through a wide range of engine revolutions per minute. An alternative embodiment with a hydraulic system power takeoff would require a pump (16), reservoir (21) and piping to devices that utilize pressure. An advantage of the invention is that the power output can be easily reversed to power input, providing the ability to store energy in the flywheel when needed or to employ regenerative braking for a vehicle in a decelerating mode.

In the preferred embodiment of the process of using the power plant, the flywheel is turned by flowing an incompressible fluid through nozzles (13) located on the circumferential housing wall.

In operation, the incompressible fluid resides predominantly in one of the outer chambers and its adjoining inner chamber, e.g. as shown in FIG. 4 the incompressible fluid is shown in the left outer chamber (40) and its adjoin inner chamber (46). The other outer chamber (41) and its adjoining inner chamber (45) are predominantly empty of incompressible fluid. The inner chamber, which is adjacent to the outer chamber where the incompressible fluid resides, contains incompressible fluid by virtue of its direct connection through the nozzles or turbine blades.

During rotation of the housing, the centrifugal effect locates the incompressible fluid in the space starting at the circumferential wall of the housing and ending a desired distance from the surface of the shaft. For initial startup, the housing must be rotated to locate the incompressible fluid in this position. This leaves a volume in that outer chamber, which is between the surface of the incompressible fluid and the surface of the shaft, available for a compressible gas to reside.

The optimum volume in the outer chamber for incompressible gas to reside above the incompressible fluid is primarily dependent on the mode for introducing a compressed gas into the chamber and efficiency of power plant operation desired for the particular load placed on the power plant.

If the compressed gas is introduced by combustion of a fuel oxygen mix in the outer chamber, then a volume of compressible gas space in the outer chamber is required to permit introduction of the fuel mix and for the ignition source to function properly.

The amount of incompressible fluid flow is dependent on the motivating energy delivered by the compressed gas. For embodiments with internal combustion in the outer chamber, this energy is directly related to the load on the power plant and the volume of incompressible fluid in the outer chamber that will drive the flywheel. Thus, the optimum incompressible fluid volume is dependent upon the application and embodiment employed.

In some embodiments, the outer chamber is filled with the incompressible fluid and a pressurized gas introduced from the spool into the filled outer chamber. The source of pressurized gas may be very large compared to the required energy required, so as to permit filling the outer chamber with incompressible fluid and driving whatever volume of such fluid is there through the nozzles or turbines, almost independently of the load on the power plant. Examples of such external sources of pressurized gas may be a tank of such gas, a compressor, or combustion external to the housing.

For many applications, the incompressible fluid is water with anti-freeze to control evaporation. In other embodiments, it may be plain water, oil or any combination of liquids that remain primarily in a liquid state to flow through the nozzles or turbine blades.

In the preferred embodiment of the process of using the power plant, the spool is first located with the ports aligned to permit introduction of the compressed gas in the outer chamber filled with the incompressible fluid, e.g., if the left outer chamber (40) were filled with incompressible fluid, then the ports (53A) in the shaft and spool would be aligned. The port (56) from the adjacent inner chamber is also open so that incompressible fluid may flow out that inner chamber (45) to the empty outer chamber (41). The exhaust port (52B) in the empty outer chamber (41) is also opened.

A charge of compressed gas is then introduced into the filled outer chamber. This motivates the incompressible fluid to flow through the nozzles (13) to adjacent inner chamber and thence to the other outer chamber. As the incompressible fluid flows through the nozzles, it turns the housing (10), storing the energy in its rotational speed. As the incompressible fluid transfers to the empty outer chamber, the exhaust port in that chamber permits the compressible gas in that chamber to be exhausted from the chamber.

When the incompressible liquid is transferred to the other outer chamber, the spool is activated to its alternate location, closing the compressed gas port (53A in the example) to the now empty chamber, opening its exhaust port (52A in the example) and closing the port (56 in the example) from its adjacent inner chamber. Simultaneously, the compressed gas port (53B) in the now filled chamber (41 in the example) is opened, the port (55) from its adjacent inner chamber is opened, and the filled chamber's exhaust port (52B) is closed. The power plant is then in position to repeat the process in the other direction.

While there has been described herein what is considered to be the preferred exemplary embodiment of the present invention, other modifications of the present invention shall be apparent to those skilled in the art from the teachings herein, and it is therefore, desired to be secured in the appended claim all such modifications as fall the true spirit and scope of the invention. Accordingly, what is desired to be secured by Letters Patent of the United States the invention as defined and differentiated in the following claims in which I claim:

What is claimed is:

1. A power plant employing an incompressible fluid and a compressible fluid comprising,
(a) a ported, tubular non-rotating shaft having radial projections of circular shape extending from the exterior of said shaft;
(b) a housing rotatably sealed and mounted on said shaft, wherein said housing provides an enclosure and by almost meeting said projections creates at least one set of chambers composed of a left outer chamber, a right outer chamber and two inner chambers therebetween, and wherein each such outer chamber encloses at least three sets of two ports on the shaft and each inner chamber encloses at least one set of two ports on the shaft;
(c) a ported spool with flow channels fitting within said shaft, wherein the axial movement of said spool opens or closes the ports in said shaft to alternatively permit in each set of chambers fluid communication between an inner chamber and the outer chamber not adjacent to it, while at the same time maintaining a fluid communication path between the outer chambers and outside the housing;
(d) a means for imparting rotational energy to said housing by fluid flow from an outer chamber in each set through an adjacent inner chamber to the other outer chamber; and
(e) a means for pressurizing a compressible fluid in each outer chamber.

2. The power plant of claim 1 wherein said means for imparting rotational energy is a plurality of nozzles mounted in two rows on the internal circumference of the housing such that said nozzles permit fluid communication within each set between each outer chamber and its immediately adjacent inner chamber.

3. The power plant of claim 1 wherein said means for imparting rotational energy are turbine blades circumferentially mounted in two rows on the inner surface of the housing and extending radially downward, each row of blades to terminate in close proximity to the tops of two radial projections extending from the shaft and forming inner walls of the outer chambers.

4. The power plant of claim 1 further comprising means for controlling precessional forces from the rotating housing.

5. The power plant of claim 1 wherein the means for pressurizing a compressible fluid is combustion within each outer chamber.

6. The power plant of claim 1 wherein the means for pressurizing a compressible fluid is by introduction of a pressurized gas from a source external to the housing.

7. The power plant of claim 1 further comprising a means for transferring the rotational energy of the housing to other devices.

8. The power plant of claim 7 wherein the means for transferring the rotational energy is a connected hydraulic system composed of a pump, reservoir and piping to devices that utilize pressure.

9. The power plant of claim 7 wherein the means for transferring the rotational energy is a connected electric motor.

10. The power plant of claim 7 wherein the means for transferring the rotational energy is a connected drive shaft.

11. A process for using the power plant of claim 1 comprising the steps of,
(a) partially filling the left outer chamber with an incompressible fluid;
rotating the housing such that the incompressible fluid radially extends to the housing;
(b) positioning the spool such that an incompressible fluid entering the inner chamber adjacent to said left outer chamber may flow through the bottom port in said inner chamber through the spool to the right outer chamber;
(c) introducing a compressed gas charge into said left outer chamber;
(d) re-positioning the spool such that the inner chamber located next to said right outer chamber flowably communicate with the left outer chamber;
(e) introducing a compressed gas charge into said right outer chamber;
repeating steps (c) through (f) to continue the process.

12. The process of claim 12 wherein the compressed gas charge is introduced by combustion within each outer chamber.

13. The process of claim 12 wherein the compressed gas charge is introduced by combustion external to the housing.

14. The process of claim 12 wherein the compressed gas charge is introduced by pressurized gas source external to the housing.
